(19) United States
(12) Patent Application Publication
(10) Pub. No.: US 2006/0126459 A1
(43) Pub. Date: Jun. 15, 2006

(54) Optical pickup device with phase shift mirror

(75) Inventors: Jong Won Moon, Gyeonggi-do (KR); Sang Hwan Choi, Gyeonggi-do (KR); Mi Hye Jeon, Seoul (KR); Jong Ryull Kim, Gyeonggi-do (KR); Jung Woo Seo, Gyeonggi-do (KR); Ho Sik You, Gyeonggi-do (KR)

Correspondence Address: DARBY & DARBY P.C., P. O. BOX 5257, NEW YORK, NY, 10150-5257, US

(73) Assignee: Samsung Electro-Mechanics Co., Ltd., Gyeonggi-do (KR)

(21) Appl. No.: 11/301,460

(22) Filed: Dec. 12, 2005

(30) Foreign Application Priority Data
Dec. 14, 2004 (KR) 10-2004-0105626

(51) Int. Cl. G11B 7/00

(52) U.S. Cl. 369/44.37; 369/112.01; 369/112.28

(57) ABSTRACT

The present invention relates to an optical pickup device having a phase shift mirror, which universally adopts light sources for recording on and/or reproducing from both CDs and DVDs. In the optical pickup device with double light sources for CDs and DVDs, beams can travel the optical path at maximum efficiency (e.g., transmittance for P-polarized beams and reflectance for S-polarized beams) before being incident on the phase shift mirror. Additionally, because it employs a single element PS-MR instead of a mirror and a quarter wave plate, the optical pickup device can be constructed by assembling a smaller number of parts and thus have a low cost.

### INCORPORATION BY REFERENCE

The present application claims priority under 35 U.S.C. §119 to Korean Patent Application No. 10-2004-0105626 filed on Dec. 14, 2004. The content of the application is incorporated herein by reference in its entirety.

### BACKGROUND OF THE INVENTION

1. Field of the Invention

The present invention is in the field of an optical pickup device adopting a double light source. More particularly, the present invention relates to an optical pickup device comprising an optical system which can compatibly record on and/or reproduce from compact discs (CDs) and digital versatile discs (DVDs) and which employs a phase shift mirror so as to reduce the assembly process and the production cost.

2. Description of the Related Art

Recent advances in the storage capacity of optical discs have resulted in the development and commercialization of DVDs. With much larger storage capacity, DVDs have a higher recording density (e.g., track density) relative to CDs. DVDs have a shorter distance from a disc surface to a data recording plane than do CDs. For example, the distance from a disc surface to a data recording plane is about 0.6 mm in DVDs and about 1.2 mm in CDs. Another difference between DVDs and CDs is found in the light source they employ. While the light source for DVDs has a wavelength of 635-650 nm (visible, red), CDs employs a wavelength of 780 nm (infrared).

For this reason, a typical optical pickup device capable of being universally used for both DVDs and CDs has an optical element equipped with two different light sources, which is described in FIG. 1.

FIG. 1 shows an optical pickup device 100 employing a double light source, based on a conventional optical system, in a schematic perspective view. Herein, the double light sources are two laser diodes (LDs) emitting light beams for CDs and DVDs.

As seen in FIG. 1, the optical pickup device 100 comprises a first light source 10 (or a first laser diode) for generating light beams for CDs and a second light source 20 (or a second laser diode) for generating light beams for DVDs, a cubic beam splitter (CBS) 30 for transmitting or reflecting the beams emitted from the first and the second laser diode in accordance with the direction of polarization, a plate beam splitter (PBS) 40 for reflecting the beams emergent from the CBS 30, a collimate lens (CL) 50 for collimating the beams emergent from the PBS 40, a mirror 60 for reflecting the collimated beams upwards at right angles, a quarter wave plate (QWP) 70 for turning the beams reflected from the mirror into circularly polarized light, an objective lens (OL) 80 for focusing the circularly polarized beams emergent from the QWP 70 onto a spot on a surface (e.g., recording plane) of an optical disc (not shown), and a photodetector 90 for detecting the beams transmitted from the disc through the objective lens 80, the QWP 70, the mirror 60, the CL 50 and the PBS 40 in sequential order and converting them into electric signals.

In this conventional optical system, the first laser diode 10 and the second laser diode 20 emit light beams at different wavelengths, which are selectively transmitted through or reflected by the beam splitters 30 and 40 according to both the wavelength and direction of polarization or to the direction of polarization alone. The CL 50 makes the light beams transmitted through beam splitters 30 and 40 parallel. The parallel light beams are reflected upwards at a right angle, followed by being conversed into circularly polarized beams by the QWP 70 before passing through the OL 80. The light beams emergent from the OL 80 are focused onto a surface of the optical disc to record on or reproduce from the surface (information recording plane).

On the other hand, after traveling the aforementioned path in reverse, the light beams reflected from the surface of the optical disc (information recording plane) are transmitted to and converted into electrical signals by the photodetector integral circuit (PDIC) 90. The actual backward path includes the OL 80, the QWP 70, the mirror 60, the CL 50, the PBS 40, and the PDIC 90 in sequential order.

Optionally, a sensor lens 92 for sensing focus-error signals using an astigmatic method may be positioned between the PBS 40 and the PDIC 90. Additionally, a diffraction grating 12 and a diffraction grating 22 may be installed between the first laser diode and the CBS 30 and between the second laser diode 20 and the CBS 30, respectively.

As described above, the conventional optical pickup device which employs light beams of different wavelengths generated from light sources is designed to turn linearly polarized beams of P and S waves into circularly polarized beams and thus requires the QWP as a necessary optical element.

Because it requires many optical elements for utilizing double light sources to record on or reproduce from different kinds of optical discs, the conventional optical pickup device has a complicated structure which suffers the disadvantage of being difficult to construct and being produced at a high cost.

### SUMMARY OF THE INVENTION

Accordingly, the present invention has been made keeping in mind the above problems occurring in the prior art, and an object of the present invention is to provide an optical pickup device which employs a smaller number of parts.

It is another object of the present invention to provide an optical pickup device which can effectively transmit/reflect beams emitted from double light sources.

In accordance with an embodiment of the present invention, there is provided an optical pickup device, including, a first light source for generating light beams for CDs, a second light source for generating light beams for DVDs, a cubic beam splitter for selectively transmitting or reflecting incident beams according to wavelength and direction of polarization, a plate beam splitter for transmitting or reflecting incident beams according to direction of polarization, a collimate lens for collimating the beams emergent from the plate beam splitter, a phase shift mirror for orthogonally reflecting the collimated beams emergent from the collimate lens, the beams reflected from the phase shift mirror being phase shifted by a quarter wavelength, an objective lens for focusing the phase-shifted beams onto the surface of an optical disc, and a photodetector integrated circuit for detecting and converting beams into electric signals, said beams being reflected from the surface of the optical disc and transmitted through the objective lens, the phase shift mirror, the collimate lens and the plate beam splitter.

Accordingly, the optical pickup device of the present invention can be easily assembled from fewer parts because the phase shift mirror can perform the functions of both a conventional mirror and a conventional quarter wave plate. Also, the present invention has the feature that the cubic beam splitter is rotated so that beams are incident on the phase shift mirror, with the directions of polarization tilted at a predetermined angle with respect to the surface of the phase shift mirror, while the light sources are arranged according to the rotation of the cubic beam splitter, thereby utilizing the phase shift mirror to appropriately turn the linearly polarized beams into circularly polarized beams.

Optionally, the optical pickup device according to the present invention may further comprise a sensor lens for sensing a focus error between the photodetector integrated circuit and the plate beam splitter and/or a diffraction grating between the first light source and the cubic beam splitter and between the second light source and the cubic beam splitter.

In the present invention, linearly polarized beams are incident on the phase shift mirror with the directions of polarization tilted at a predetermined angle with respect to the surface of the phase shift mirror, and are shifted in phase by a quarter wavelength, and thus emerge as circularly polarized beams after being reflected by the phase shift mirror.

In an embodiment of the present invention, the cubic beam splitter is arranged with a predetermined rotation angle with respect to the optical axis of any one of the light sources such that the direction of polarization of the beams incident on the phase shift mirror is tilted at a predetermined angle while the polarized beams are maximally maintained in their optical path before entering the phase shift mirror.

In one embodiment, the cubic beam splitter is rotated on the optical axis of the beams which pass through the cubic beam splitter so that the light source emitting beams which are reflected by the cubic beam splitter are positioned at a predetermined angle with respect to the optical axis of the beams passing through the cubic beam splitter.

In an embodiment of the present invention, the first light source emits beams which pass through the cubic beam splitter while the second light source emits beams which are reflected by the cubic beam splitter.

In an embodiment of the present invention, the cubic beam splitter consists of two sheets of glass, with a dichroic coating at a conjunction plane therebetween, said dichroic coating functioning to transmit or reflect the light beams incident on the conjunction plane of the cubic beam splitter, depending on wavelengths and directions of polarization.

In an embodiment of the present invention, the directions of polarization of the beams incident on the phase shift mirror are tilted at approximately 45 degrees with respect to the plane of incidence.

Consequently, in accordance with the embodiments of the present invention, the cubic beam splitter is rotated and the first and the second light source are arranged according to the rotation, so that the polarized beams emitted from the light sources are incident on the cubic beam splitter, with the directions of polarization tilted at a predetermined angle, while maintaining maximum optical efficiency.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic perspective view showing an optical pickup device adopting a conventional optical system;

FIG. 2 is a circuit perspective view showing an optical pickup device adopting an optical system according to the present invention;

FIG. 3 is a graph in which the transmittance and reflectance of beams at the junction plane of the cubic beam splitter are plotted versus wavelength according to the direction of polarization;

FIG. 4 is a view showing the conversion of linearly P-polarized beams into circularly polarized beams in the phase shift mirror; and

FIG. 5 is a view showing the convention of linearly S-polarized beams into circularly polarized beams in the phase shift mirror.

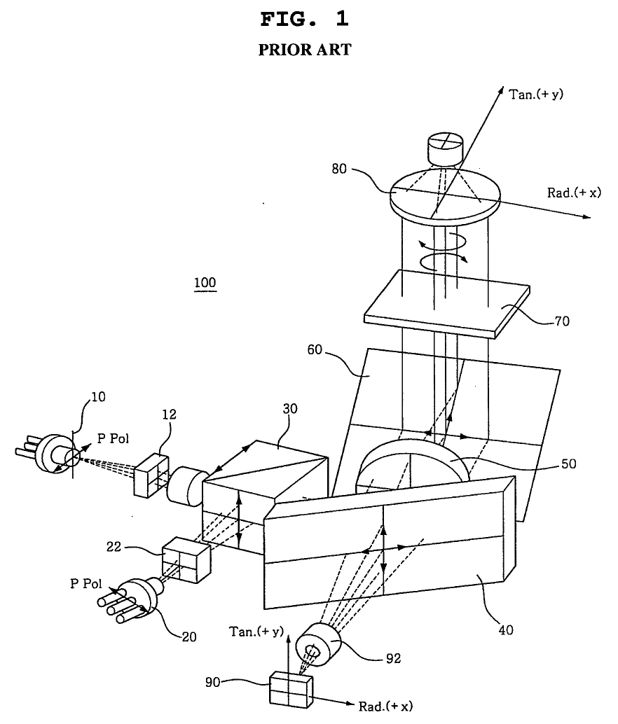

### DETAILED DESCRIPTION OF THE INVENTION

Reference should now be made to the drawings, in which the same reference numerals are used throughout the different drawings to designate the same or similar components.

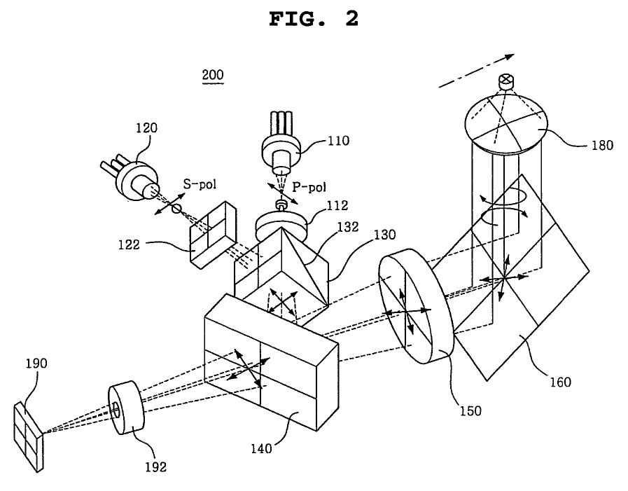

With reference to FIG. 2, an optical pickup device 200 adopting a double light source, based on an optical system according to the present invention, is shown in a schematic perspective view. As seen in FIG. 2, the optical pickup device 200 comprises a first laser diode (or a first light source) 110 for generating light beams for CDs and a second laser diode (or a second light source) 120 for generating light beams for DVDs, a cubic beam splitter (CBS) 130 for transmitting or reflecting the beams emitted from the first and the second laser diodes according to the wavelength and the direction of polarization, a plate beam splitter (PBS) 140 for reflecting the beams emergent from the CBS 130, a collimate lens (CL) 150 for collimating the beams emergent from the PBS 140, a phase shift mirror (PS-MR) 160 for turning the collimated light beams into circularly polarized light beams and then reflecting the circularly polarized light beams upwards at right angles, an objective lens (OL) 180 for focusing the circularly polarized beams emergent from the PS-MR 160 onto a spot on a surface (i.e., recording plane) of an optical disc (not shown), and a photodetector 190 for detecting the beams transmitted from the disc through the objective lens 180, the PS-MR 160, the CL 150 and the PBS 140 and converting them into electric signals.

Details will be given of the optical elements utilized in the embodiments of the present invention.

The first light source 110 is a laser diode which emits light beams for CDs (wavelength 780 nm, infrared). In an embodiment of the present invention, the light beams emitted from the first light source 110 are polarized to P waves (hereinafter referred to as “P-polarized beams”) in the CBS 130. As for the second light source 120, it is a laser diode emitting light beams for DVDs (wavelength 635-650 nm, visible, red), which are polarized to S waves (hereinafter referred to as “S-polarized beams”) in the CBS 130.

The CBS 130, also called the dichroic beam splitter (DBS), consists of two sheets of glass, with a dichroic coating at a conjunction plane 132 therebetween. The dichroic coating functions to transmit or reflect the light beams incident on the conjunction plane 132 of the CBS 130, depending on wavelength and direction of polarization.

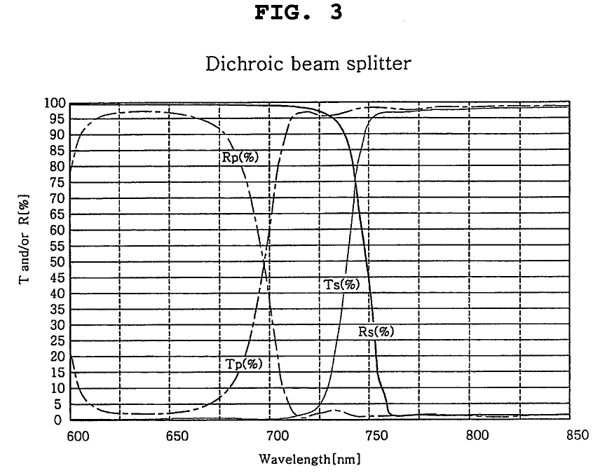

The principle of the selective transmission or reflection in the CBS is illustrated in FIG. 3 which is a plot showing changes in the beam transmittance and reflectance of the junction plane (dichroic coating surface) of the CBS versus wavelength according to the direction of polarization.

The first light source, which is a laser diode for CDs, emits P-polarized beams with a wavelength of 780 nm. As seen in FIG. 3, the junction plane shows a transmittance of near 100% (i.e. 97-98%) (Tp) and, correspondingly, a reflectance of near 0% (Rp) for P-polarized beams at 780 nm. Accordingly, the P-polarized beams from the first light source almost completely pass through the CBS.

Likewise, the S-polarized beams with a wavelength of 635-650 nm which are generated by the second light source, that is, a laser diode for DVDs, are reflected, as seen in FIG. 3, at near 100% (i.e. 99-100%) (Rs) by the junction plane, correspondingly showing a transmittance of near zero % (Ts). Accordingly, the S-polarized beams from the second light source are almost completely reflected in the CBS.

As such, the CBS 130 selectively transmits and reflects the light beams emitted from the first and second light, whereby the light beams can take the same optical path leading to the PBS 140. The beams transmitted from the CBS 130 are reflected and thus directed towards the CL 150 by the PBS 140. Primarily, the PBS 140 functions to selectively reflect or transmit some of the beams incident thereon. In one embodiment of the present invention, the PBS 140 is used to reflect the beams from the CBS 130 into the CL 150 while transmitting the beams from the CL 150 to the sensor lens 192 through which the beams reach the photodetector 190.

Then, the CL 150 collimates the beams reflected from the PBS 140 before allowing them to travel to the PS-MR 160. In an embodiment of the present invention, the CL 150 is positioned between the PBS 140 and the PS-MR 160. However, other positions for the CL 150 are possible. For instance, the CL 150 may be interposed between the CBS 130 and the PBS 140.

As one of the most characteristic optical elements used in the present invention, the PS-MR 160 is capable of turning linearly polarized beams into circularly polarized beams as well as orthogonally reflecting incident beams. To serve this function, the PS-MR 160 has a coating corresponding to a QWP on its surface. At this time, the emergence of circularly polarized beams from the PS-MR 160 requires that the linearly polarized beams be incident on the PS-MR 160, with the direction of polarization tilted at a predetermined angle.

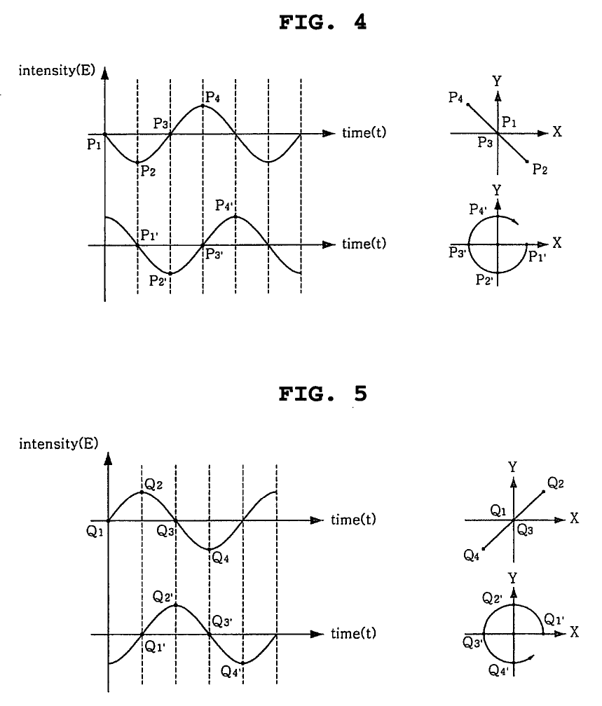

Before a detailed explanation for the conditions under which the direction of polarization of the linearly polarized beams is tilted at a predetermined angle, for example, at 45 degrees with respect to the incident plane of the PS-MR, the principle of the conversion of incident linearly polarized beams into circularly polarized beams in the PS-MR is explained with reference to FIGS. 4 and 5.

FIGS. 4 and 5 depict examples in which, when linearly polarized beams are incident on the PS-MR, with the direction of polarization tilted at 45 degrees with respect to the surface (X-Y axes) of the PS-MR, a phase shift of a quarter wave occurs, resulting in the incident linearly polarized beams being turned into circularly polarized beams.

In the upper section of FIG. 4, the linearly polarized beams having a tilt in the upper leftward/lower rightward direction with respect to the surface (X-Y axes) of the PS-MR (the right panel) are expressed as a wave in a time (t)-intensity (E) coordinate (left panel). If their phase is shifted (retarded) by a quarter wavelength, the beams are expressed as a wave shown in the lower left panel. The quarter wave-shifted beams emerge as clockwise circularly polarized beams (lower right panel) before being reflected from the PS-MR. In detail, points P₁, P₂, P₃, P₄, . . . on the plot of the linearly polarized beams are respectively converted into points P₁′, P₂′, P₃′, P₄′, . . . on the plot of the circularly polarized beams due to the quarter wavelength shift.

In FIG. 5, likewise, the linearly polarized beams having a tilt in the lower leftward/upper rightward direction with respect to the surface (X-Y axes) of the PS-MR (the right panel) are expressed as a wave in a time (t)-intensity (E) coordinate (left panel). If their phase is shifted (delayed) by a quarter wavelength, the beams are expressed as the wave shown in the lower left panel. The quarter wave-shifted beams emerge as counterclockwise circularly polarized beams (lower right panel) before being reflected from the PS-MR. In detail, the quarter wavelength shift causes points Q₁, Q₂, Q₃, Q₄, . . . on the plot of the linearly polarized beams to be converted respectively into points Q₁′, Q₂′, Q₃′, Q₄′, . . . on the plot of the circularly polarized beams.

In accordance with the present invention, when incident on the PS-MR, the polarized beams, having a tilt at a predetermined angle (e.g., 45 degrees) with respect to the plane of incidence, are reflected and emerge as circularly polarized beams. Accordingly, instead of individual conventional optical elements including a conventional QWP and a conventional mirror, the PS-MR alone can be used in an optical system adopting a double light source. The only requirement is that the direction of polarization of the incident linearly polarized beams be tilted at a predetermined angle (e.g., 45 degrees) so as to accomplish the conversion into circularly polarized beams in the PS-MR.

Through the OL 180, the circularly polarized beams emergent from the PS-MR 160 are focused onto a spot on a surface (data recording plane) of the optical disc to record on and/or reproduce from the optical disc.

When being reflected from the optical disc, light beams are transmitted through the OL 180 and then reflected from the PS-MR 160 through the CL 150 and the PBS 140 to the photodetector 190, in which the reflected beams are converted into electrical signals.

As in conventional optical pickup devices, the sensor lens 192 for sensing focus errors may be interposed between the PBS 140 and the photodetector 190. Additionally, diffraction gratings 112 and 122 may be installed between the first laser diode 110 and the CBS 130 and between the second laser diode 120 and the CBS 130, respectively.

As aforementioned, the present invention has the feature that when polarized beams are incident on the PS-MR with the direction of polarization tilted at a predetermined angle, they are allowed to remain linearly polarized in their optical path before entering the PS-MR, with their optical efficiency maximized.

To this end, the present invention proposes a structure in which the CBS, which allows beams emitted from light sources to take the same optical path using selective transmission or reflection, is rotated at a predetermined angle. In detail, the CBS is rotated on the optical axis of the light source emitting beams which pass through the CBS, (i.e., the first light source for CDs) and the direction of the first light source is also changed to a predetermined angle, so that the P-polarized beams from the first light source pass through the CBS, with the direction of polarization tilted with respect to the plane of incidence of the CBS. Concurrently, the second light source is arranged according to the CBS, which is rotated around the optical axis of the first light source, so that the S-polarized beams from the second light source are reflected by the CBS, with the direction of polarization tilted with respect to the plane of incidence of the CBS. In an embodiment of the present invention, as the CBS rotates at about 45 degrees, the second light source is tilted by about 45 degrees with respect to the optical axis of the first light source.

Beams emitted from the first and second light source which are rearranged according to the rotation of the CBS travel the optical path of the CBS, the PBS and the CL to the PS-MR.

The angle at which the CBS is rotated is not limited by the above-described embodiment of the present invention, but may be any value satisfying the condition under which linearly polarized beams are incident on the PS-MR, with the direction of polarization tilted at a predetermined angle with respect to the plane of incidence, in detail, under which linearly polarized beams are phase shifted by a quarter wavelength in the PS-MR so as to emerge as circularly polarized beams.

As a matter of course, the beams which have traveled the same optical path behind the CBS must be effectively reflected by the PBS. For example, under the assumption that the P-polarized beams (the first light source) and the S-polarized beams (the second light source) show the same reflectance in the PBS, the suggested rotation angle of the CBS is 45 degrees in an embodiment of the present invention. Accordingly, if the reflectance in the PBS between the P-polarized beams (the first light source) and the S-polarized beams (the second light source) differs, the CBS may be rotated by a corresponding degree. Also in this case, of course, the linearly polarized beams must be incident on the PS-MR at an angle of approximately 45 degrees with respect to the plane of incidence.

As described hereinbefore, the present invention provides an optical pickup device adopting a double light source for CDs and DVDs, in which beams can progress with a high efficiency (e.g., transmittance for P-polarized beams and reflectance for S-polarized beams in the CBS).

In addition, because it employs the single element PS-MR instead of a mirror and a QWP, the optical pickup device according to the present invention can be constructed by assembling a smaller number of parts and thus have a low cost.

Although the embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An optical pickup device, comprising:
a first light source for generating light beams for CDs;
a second light source for generating light beams for DVDs;
a cubic beam splitter for selectively transmitting or reflecting at least one of incident light beams for CDs and for DVDs according to wavelength and direction of polarization of the light beams for CDs and for DVDs;
a plate beam splitter for transmitting or reflecting incident light beams for CDs and for DVDs according to direction of polarization of the light beams for CDs and for DVDs;
a collimate lens for collimating the light beams for CDs and for DVDs emerging from the plate beam splitter;
a phase shift mirror for orthogonally reflecting and phase shifting by a quarter wavelength at least one of the collimated light beams for CDs and for DVDs emerging from the collimate lens;
an objective lens for focusing at least one of the phase-shifted light beams for CDs and for DVDs onto a surface of an optical disc; and
a photodetector integrated circuit for detecting and converting at least one of the light beams for CDs and for DVDs into electric signals, the light beams for CDs and for DVDs being reflected from the surface of the optical disc and transmitted through the objective lens, the phase shift mirror, the collimate lens, and the plate beam splitter.

2. The optical pickup device as defined in claim 1, wherein collimated light beams for CDs and for DVDs having a direction of polarization tilted at a predetermined angle with respect to a plane of incidence of the phase shift mirror, are incident on the phase shift mirror, and phase shifted by quarter wavelength in the phase shift mirror, and emerge as circularly polarized beams from the phase shift mirror.

3. The optical pickup device as defined in claim 2, wherein the predetermined angle is approximately 45 degrees.

4. The optical pickup device as defined in claim 2, wherein the cubic beam splitter has a predetermined rotation angle with respect to an optical axis of the first or second light source such that the direction of polarization of the light beams incident on the phase shift mirror is tilted at the predetermined angle and the polarized light beams maintain maximum efficiency in their optical path before entering the phase shift mirror.

5. The optical pickup device as defined in claim 4, wherein the cubic beam splitter is rotated on the optical axis of the light beams passing therethrough, and, at least one of the first or second light source for generating the light beams which are reflected by the cubic beam splitter has the predetermined angle with respect to the optical axis of the light beams passing through the cubic beam splitter.

6. The optical pickup device as defined in claim 1, wherein the first light source generates light beams which pass through the cubic beam splitter.

7. The optical pickup device as defined in claim 1, wherein the second light source generates light beams which are reflected by the cubic beam splitter.
